(19) United States
(12) Patent Application Publication
(10) Pub. No.: US 2003/0044524 A1
(43) Pub. Date: Mar. 6, 2003

(54) Vibratory electrostatic fluidized bed for powder paint coating

(76) Inventor: Derrick B. Hoffland, Crystal Lake, IL (US)

Correspondence Address: GARDNER, CARTON & DOUGLAS, PATENT DOCKET DEPT., 321 N. CLARK STREET - SUITE 3400, CHICAGO, IL, 60610, US

(21) Appl. No.: 09/947,883

(22) Filed: Sep. 5, 2001

(51) Int. Cl. B05D 1/12

(52) U.S. Cl. 427/180; 427/475; 118/621; 118/309

(57) ABSTRACT

The device and method of the invention utilizes a vibratory trough or bed to triboelectrically charge powder paint particles. The trough is lined with polytetrafluorethylene or any other material having a dielectric constant sufficient to triboelectrically charge paint particles such that oscillation of the paint particles by a motor charges the particles. The motor has an unbalanced weight sufficient to cause a vibration on the trough. The fluidized and subsequently charged particles then attach to a grounded workpiece.

### FIELD OF THE INVENTION

This invention relates to an apparatus for triboelectrically charging powder paint and a method for depositing the same on a grounded workpiece.

### BACKGROUND OF INVENTION

Tribo electricity is a method of electrostatically charging a material. An electrostatic charge is generated by friction of one material against another. In other words, materials with different physico-chemical properties can exchange electrons when brought into direct contact with each other. Some materials easily give up electrons while other materials readily accept them. Friction simply improves the contact between the materials and facilitates electron exchange.

Tribo-charging powder spray guns are designed to provide for multiple collisions of powder particles with a charging surface inside the gun. As a result of these multiple collisions, a charge is transferred between the surface and the particles. The coating is then applied by an electrostatic powder spray. For example, a manual or automatic gun imparts a charge to a paint particle wherein the particle is then deposited on a grounded workpiece. The charging is accomplished by either a corona field or by triboelectric contact. In a corona gun, there is a high voltage electrical source at the end of the gun which creates an ion field between the gun and the grounded workpiece. As the paint is sprayed through the field, it takes on a charge as it collides with ions. The charged paint is attracted to the grounded workpiece and the paint film is built. In a triboelectric gun, the paint particles are forced through a polytetrafluorethylene “PTFE” lined pathway inside the gun. As the powder collides with the PTFE, it is triboelectrically charged due to the differing dielectric constants of the paint particles and the PTFE. The charged paint is then expelled from the gun and deposited on the grounded workpiece.

One example of the powder spray gun is U.S. Pat. No. 6,003,779 to Robidoux. Robidoux discloses a spray gun for applying powder to coat a workpiece using a triboelectric and optionally a corona discharge. The gun communicates with a source of pressurized air through the handle with an air valve controlling the flow of air. Powder in a container is in fluid communication with the air flow such that it becomes fluidized and entrained when the valve is opened. The powder then exits through a nozzle, passing a corona discharge electrode which produces a corona that charges the powder. A perforated disk is then disposed at an open end of the nozzle to provide an even dispersal of the powder on the grounded target.

Another method for applying powder coating is the electrostatic fluidized bed or ESFB. In this method, a trough of powder sits over a perforated plate. Below the perforated plate lies an air plenum that contains a high voltage electrode. As air is passed through the plenum, the air becomes ionized by the electrode. The ionized air is then forced up through the perforated plate and the powder paint. The collisions between the ions and the powder impart a charge to the powder particles. These charged powder particles form a cloud over the fluidized bed. When a grounded workpiece is passed through this cloud, the charged paint particles are attracted to the workpiece and the film is built. Because the charged powder deposits so rapidly on the part to be coated, it is very difficult to get a coating of uniform thickness from top to bottom on elongated articles. To minimize the problem, part rotation of the workpiece is normally employed. Typically, the ESFB coating process is used to only coat small or two-dimensional objects such as window screening.

The use of sieves in powder spray systems serves two functions. It assists in removing contamination from the powder and conditions the powder for spraying. One type of sieve used in powder spray systems is the vibratory sieve. Vibratory sieves have a screen stretched over a supporting frame. An electrical or mechanical vibrator causes the screen to vibrate against the powder. This vibratory motions causes the powder to spread over the area of the screen allowing the smaller particles to fall through the open pores. Over time the particles become smaller and tend to lose their charge thus having a negative impact on the coating of the workpiece. The screen allows the smaller particles to fall through thus reducing uneven coating of the workpiece. Vibratory sieves range from the simple “tambourine” style which collect the smaller particles on the screen and must be manually dumped out, to more sophisticated models with automatic outlets for removing the smaller particles.

The powder spray guns have a number of deficiencies. The powder spray gun can only cover a limited area on the workpiece. Because the gun is focused on a specific area, large workpieces cannot quickly be covered with paint particles. Furthermore, the powder spray gun can hold only a limited amount of paint before it must be refilled.

The ESFB coating process also has a number of deficiencies as the ESFB requires ionized air which is costly to maintain. The ESFB thus requires complex machinery including an air compressor, filters, regulators, dryers, electrodes and a high voltage supply resulting in substantially costs. In addition, the ESFB can only hold two to four inches of powder paint in the bed which severely restricts the size of the workpiece that can be used with the ESFB.

### SUMMARY OF INVENTION

A primary object of the present invention is to provide a fluidized bed that does not require ionized air and thus substantially reduces the cost of powder coating using a fluidized bed.

A further object of the present invention is to provide a fluidized bed wherein a large workpiece may be dipped or passed through such that an even powder coating is applied to the workpiece in a controlled film build.

In accordance with the principles of the present invention, there is provided a vibratory fluidized bed lined with polytetrafluorethylene (“PTFE”). The vibratory bed is filled with powder paint and vibrated such that the resulting oscillations of the paint particles against the PTFE material triboelectrically charge the paint particles. The fluidized, charged paint particles then form a cloud over the bed and a grounded workpiece is either passed through the cloud or dipped in the bed to form a coating over the workpiece. The vibratory trough can be of either a single mass (brute force) or of two mass design such that the vibration can be induced by the rotation of an unbalanced weight on a motor shaft, the use of a pneumatic vibrator or an electromagnetic vibrator.

### BRIEF DESCRIPTION OF THE DRAWINGS

FIG. 1 is a side view of an embodiment of the vibratory electrostatic fluidized bed for powder paint coating in accordance with the principles of the present invention.

FIG. 2 is a side view of an embodiment of the vibratory electrostatic fluidized bed for powder paint coating in accordance with the principles of the present invention having a screen.

FIG. 3 is a side view of an embodiment of the vibratory electrostatic fluidized bed for powder paint coating in accordance with the principles of the present invention having pillars and dividers.

FIG. 4 is a side view of an embodiment of the vibratory electrostatic fluidized bed for powder paint coating in accordance with the principles of the present invention having a gate.

### DETAILED DESCRIPTION OF THE PREFERRED EMBODIMENT

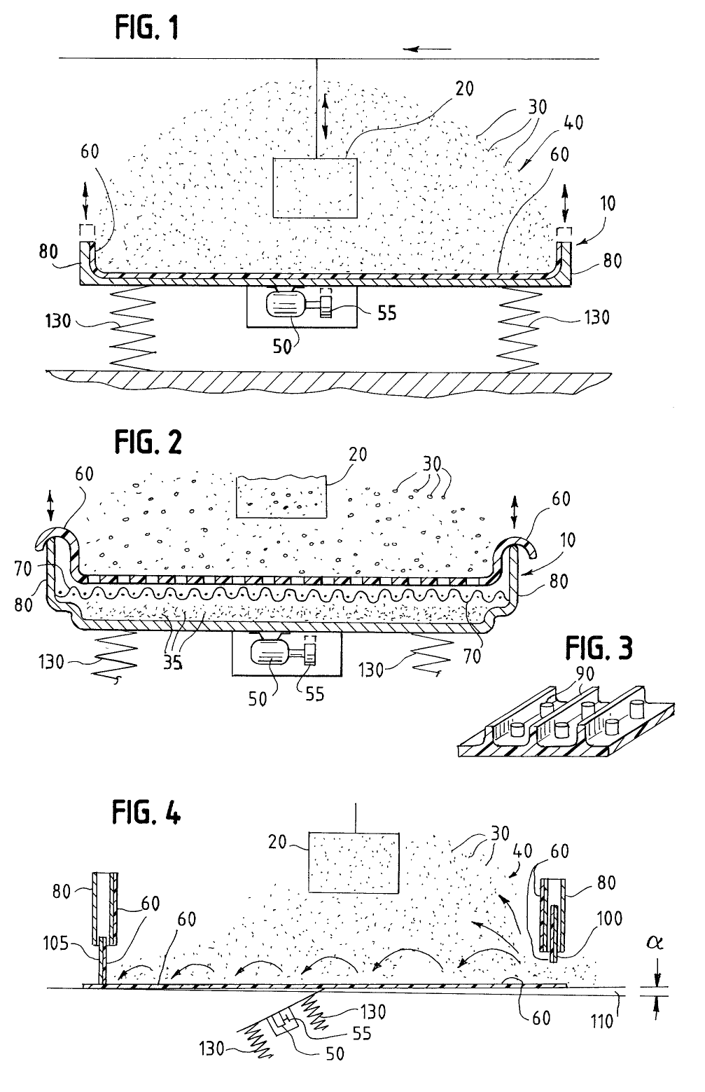

Referring to FIG. 1, the numeral 10 designates one schematic embodiment of the vibratory electrostatic fluidized bed powder paint coating (“VESFB”) of the present invention. While this embodiment will serve to illustrate some embodiments of the present invention, it will be understood by those skilled in the art that the configuration of the VESFB may vary considerably within the scope of this invention depending on the particular article(s) to be painted.

In the embodiment of the present invention for a VESFB 10 as illustrated in FIG. 1, a vibratory fluidized bed or trough 80 is lined with a material having a dielectric constant sufficient to triboelectrically charge paint particles. In the embodiment discussed herein, a material having a low dielectric constant will be used such as PTFE 60, though other materials having a low dielectric constant that easily accept electrons such as polypropene, polyethylene and polystyrene may be used. As will be appreciated by those skilled in the art, materials having a high dielectric constant may also be used. The vibratory bed is a trough or other like container made of any type of metal such as steel or aluminum. As will be appreciated by one skilled in the art, a steel trough should be grounded as a safety precaution.

The trough 80 is filled with powder paint particles 30, although other particles that become electrically charged may also be utilized in the present invention. The trough 80 is then vibrated at a high frequency by mechanical or other means. As the trough containing the paint particles 30 vibrates, the powder paint particles 30 lose electrons and becomes positively charged by the oscillation of the paint particles 30 against the PTFE lined trough 80. The oscillation of the paint particles against the PTFE 60, therefore, triboelectrically charges the paint particles 30.

The vibration of the trough 80 may be induced by the rotation of an unbalanced weight on a motor shaft in the embodiment shown in FIG. 1. The motor 50 is connected to the trough 80 and the unbalanced weight 55 causes vibration to the trough 80. Additionally, vibration may be induced by a pneumatic vibrator, an electromagnetic vibrator or a remote motor or by any other means known to those having ordinary skill in the art.

As the paint particles 30 subsequently become fluidized by the vibration and triboelectrically charged, the paint particles 30 form a cloud 40 over the bed of the trough 80. A grounded workpiece 20 of various size may then be passed through the cloud 40. As the grounded workpiece 20 is passed through the cloud 40, the fluidized, positively charged particles become attracted to the workpiece 20 such that a coating of film covers the workpiece 20. Alternatively, the grounded workpiece 20 may also be dipped into the fluidized bed of paint particles 30 rather than passing the grounded workpiece 20 through the cloud 20 above the bed. This produces a significant advantage over the prior art devices. Because air is not passed through the paint particles such as that used in an electrostatic fluidized bed, more paint particles may be added to the trough. Typically, an electrostatic fluidized bed can only hold paint particles to a depth of two to four inches due to the inefficiency of air as a fluidizing agent. Therefore, as can be seen by the present invention, larger grounded workpieces may be coated presenting a significant advantage over the prior art.

The number of charged particles in the VESFB 10 can be controlled by the frequency of vibrations. This in turn enables the user to control the amount of paint particle buildup on the grounded workpiece 20. As the frequency of vibrations increases over time, the number of oscillations and resulting collisions with the PTFE 60 material also increases. Therefore, as the contacts increase, the number of charged paint particles also increases which results in a greater film thickness of the paint particles 30 on the grounded workpiece 20.

In an alternate embodiment of the present invention for a VESFB 10, there is provided a screen 70, the screen 70 positioned below the PTFE 60 as shown in FIG. 2. The PTFE 60 and screen 70 are perforated such that the larger paint particles 30 remain above the screen 70 while smaller particles 35 and other impurities fall and become trapped below the screen 70. Typically, the larger paint particles 30 will attach to the grounded workpiece 20, but the smaller particles 35 have difficulty retaining their charge. As the charge of the smaller particles 35 is lost, they filter through the screen 70 and become lodged below. The retaining area 75 below the screen 70 can be cleared of the smaller particles 35 and other impurities either manually or by disposing of the particles automatically through means generally known in the art. One primary advantage of the screen 70 is that the larger particles 30 above the screen 70 that ultimately attach to the grounded workpiece 20 are generally similar in size. The resulting effect is a better coating of film upon the workpiece 20.

In another alternate embodiment of the present invention for a VESFB 10 as is illustrated in FIG. 3, the trough 80 may be provided with pillars, dividers or other structures 90. These multiple structures 90 are also lined with PTFE 60. These PTFE lined structures provide increased contacts between the oscillating paint particles 30 and the PTFE 60 as the trough 80 is vibrated. The resulting effect is a greater distribution of positive charges amongst the fluidized particles. Therefore, as described herein, because there is a greater number of positively charged particles in the trough 80, the coating of particles on the grounded workpiece 20 also increases.

In a further embodiment of the present invention for a VESFB 10, there is provided at least one trough 80 having at least one gate 100 on each side of the trough 80 as is illustrated in FIG. 4. In this particular embodiment of the present invention, a platform 110 extends along the base of the trough 80 past both gates 100, 105 on each side of the trough 80. The platform 110, like the trough 80 in prior embodiments is lined with PTFE 60 or any other type of material having a low dielectric constant and may be slightly inclined. Powder paint particles 30 are then added to one end of the platform 110 and a first gate 100 on one side of the trough 80 is opened. An exciting mechanism 50, such as a pneumatic or electromagnetic vibrator, or any other type of motor means, contacts or vibrates the platform with an angular force such that the paint particles 30 become excited and begin to oscillate. Because the motor 50 vibrates the platform 110 at an angle, the particles oscillate and begin to move along the slightly inclined platform 110 in the direction of the angular force imparted by the motor 50 upon the platform 110. As the particles oscillate, they move through and contact the trough 80 which is lined with PTFE 60 or any other type of material having a low dielectric constant. The paint particles 30, like those described in the previous embodiments of the present invention, become triboelectrically charged. As the paint particles 30 become positively charged, a cloud 40 forms over the trough 80 such that a grounded workpiece 20 of varying size can be passed through or dipped into the paint particles 30. The positively charged paint particles 30 then attach to the grounded workpiece 20. As the excited paint particles continue to move down the platform 110 through the trough 80, the second gate 105 is opened wherein the particles leave the trough 80. The particles can then be deposited in a container or otherwise that may be located at the end of the platform 110.

Once the first set of particles leaves the trough 80, a new set of particles may be added, such as a new color of paint particles. As before, the first gate 100 will open and the process will proceed again. As will be appreciated, multiple troughs may be used with multiple gates. This allows for a variety of paint particles, such as different colors or otherwise, to be used with this embodiment of the present invention.

As stated herein, the trough 80 may be of either single mass or two mass design. The trough 80 may also have attached soft isolation springs 130 as is shown in FIG. 14. The soft isolation springs 130 are designed to reduce the transmission of vibrations into the supporting floor or structure. Additionally, the oscillation of the trough 80 may be designed as either straight line at any angle as in a conveyance mechanism as described in the last embodiment of the present invention, or elliptical as in a screening application depending on the various needs of the user. The required input of force would be very small as the system can be designed to run at its natural frequency.

It should be understood that various changes and modifications preferred in the embodiment described herein will be apparent to those skilled in the art. Such changes and modifications can be made without departing from the spirit and scope of the present invention and without demising the attendant advantages. It is therefore intended that such changes and modifications be covered by the appended claims.

What is claimed is:

1. An apparatus for painting a workpiece comprising:
a trough adapted to hold powder paint particles;
a material lining the trough and having a dielectric constant sufficient to triboelectrically charge the paint particles; and
an exciting mechanism connected to the trough and adapted to induce a vibration to cause the paint particles to become fluidized and oscillate against said material to become triboelectrically charged in order to become attracted to and coat a workpiece.

2. The apparatus of claim 1 wherein said material has a low dielectric constant is polytetrafluorethylene.

3. The apparatus of claim 1 wherein the exciting mechanism is induced by the rotation of an unbalanced weight on a motor shaft.

4. The apparatus of claim 1 wherein the exciting mechanism is a pneumatic vibrator.

5. The apparatus of claim 1 wherein the exciting mechanism is an electromagnetic vibrator.

6. The apparatus of claim 1 further comprising isolation springs.

7. The apparatus of claim 1 further comprising at least one pillar, said at least one pillar lined with material having a dielectric constant sufficient to triboelectrically charge the paint particles.

8. The apparatus of claim 7 wherein said material is polytetrafluorethylene.

9. The apparatus of claim 1 further comprising at least one divider, said at least one divider lined with material having a dielectric constant sufficient to triboelectrically charge the paint particles.

10. The apparatus of claim 9 wherein said material is polytetrafluorethylene.

11. The apparatus of claim 1 further comprising a screen positioned in the trough to separate out different size particles and impurities from the paint particles used to coat the workpiece.

12. An apparatus for triboelectrically charging powder paint particles comprising:
a trough adapted to hold paint particles;
means for lining said trough; and
means for vibrating said trough so that said lining means fluidizes and triboelectrically charges the paint particles such that said particles will be attracted to and coat a workpiece passed through said paint particles.

13. The apparatus of claim 12 wherein said lining means is a material having a dielectric constant and is polytetrafluorethylene.

14. The apparatus of claim 12 wherein the vibrating mechanism is induced by the rotation of an unbalanced weight on a motor shaft.

15. The apparatus of claim 12 wherein the vibrating mechanism is a pneumatic vibrator.

16. The apparatus of claim 12 wherein the vibrating mechanism is an electromagnetic vibrator.

17. The apparatus of claim 12 further comprising isolation springs.

18. The apparatus of claim 12 further comprising at least one pillar, said at least one pillar lined with material having a dielectric constant sufficient to triboelectrically charge the paint particles.

19. The apparatus of claim 18 wherein said material is polytetrafluorethylene.

20. The apparatus of claim 12 further comprising at least one divider, said at least one divider lined with material having a dielectric constant sufficient to triboelectrically charge the paint particles.

21. The apparatus of claim 20 wherein said material is polytetrafluorethylene.

22. The apparatus of claim 12 further comprising a screen positioned in the trough to separate out different size particles and impurities.

23. An apparatus for triboelectrically charging powder paint comprising:
a trough adapted to hold paint particles;
a polytetrafluorethylene lining said trough;
an exciting mechanism connected to said trough and adapted to induce a vibration such that said paint particles become fluidized and electrically charged by oscillation of said paint particles against said polytetrafluorethylene; and
isolations springs attached to said trough.

24. The apparatus of claim 23 wherein the exciting mechanism is induced by the rotation of an unbalanced weight on a motor shaft.

24. The apparatus of claim 23 wherein the exciting mechanism is a pneumatic vibrator.

25. The apparatus of claim 23 wherein the exciting mechanism is an electromagnetic vibrator.

26. The apparatus of claim 23 further comprising at least one pillar, said at least one pillar lined with material having a dielectric constant sufficient to triboelectrically charge the paint particles.

27. The apparatus of claim 26 wherein said material is polytetrafluorethylene.

28. The apparatus of claim 23 further comprising at least one divider, said at least one divider lined with material having a dielectric constant sufficient to triboelectrically charge the paint particles.

29. The apparatus of claim 28 wherein said material is polytetrafluorethylene.

30. The apparatus of claim 23 further comprising a screen, said screen positioned in the trough to separate out different size particles and impurities.

31. A method for depositing triboelectrically charged powder paint on a workpiece comprising the steps of:
adding paint particles to a trough lined with a material having a dielectric constant sufficient to triboelectrically charge the paint particles upon vibration;
inducing a vibration in said trough by an exciting mechanism, the vibration fluidizing said paint particles and triboelectrically charging said paint particles as said paint particles oscillate against said material having the dielectric constant; and
passing a workpiece through the charged paint particles to coat the workpiece with paint.

32. The method of claim 31 further comprising the step of dipping a workpiece into said trough of paint particles.

33. The method of claim 31 wherein the vibration is induced by the rotation of an unbalanced weight on a motor shaft.

34. The method of claim 31 wherein the vibration is induced by a pneumatic vibrator.

35. The method of claim 31 wherein the vibration is induced by an electromagnetic vibrator.

36. The method of claim 31 further comprising the step of passing particles that no longer are triboelectrically charged through a screen, wherein said screen separates different size particles and impurities.

37. A method for depositing triboelectrically charged powder paint on a workpiece comprising the steps of:
adding paint particles to a trough lined with a material having a dielectric constant sufficient to charge the paint particles;
vibrating said trough at a high frequency such that said paint particles oscillate against the material and become triboelectrically charged; and
passing a grounded workpiece through said triboelectrically charged paint particles.

38. The method of claim 37 wherein the vibrating of said trough is induced by the rotation of an unbalanced weight on a motor shaft.

39. The method of claim 37 wherein the vibrating of said trough is induced by a pneumatic vibrator.

40. The method of claim 37 wherein the vibrating of said trough is induced by an electromagnetic vibrator.

41. The method of claim 37 further comprising the step of passing particles that no longer are triboelectrically charged through a screen, wherein said screen separates different size particles and impurities.

42. An apparatus for triboelectrically charging powder particles comprising:
a trough having at least one gate;
a platform extending along a base of said trough through said at least one gate and adapted to hold powder particles;
a material lining said trough and said platform and having a dielectric constant sufficient to charge paint particles; and
an exciting mechanism adapted to induce an angular force on said platform and cause said particles to move along said platform in the direction of said angular force such that said particles oscillate against the material having a dielectric constant wherein the particles become triboelectrically charged.

43. The apparatus of claim 42 wherein said material having a dielectric constant is polytetrafluorethylene.

44. The apparatus of claim 42 wherein the exciting mechanism is induced by the rotation of an unbalanced weight on a motor shaft.

45. The apparatus of claim 42 wherein the exciting mechanism is a pneumatic vibrator.

46. The apparatus of claim 42 wherein the exciting mechanism is an electromagnetic vibrator.

47. The apparatus of claim 42 further comprising isolation springs.

48. The apparatus of claim 42 further comprising at least one pillar, said at least one pillar lined with material having a dielectric constant sufficient to triboelectrically charge the paint particles.

49. The apparatus of claim 48 wherein said material is polytetrafluorethylene.

50. The apparatus of claim 42 further comprising at least one divider, said at least one divider lined with material having a dielectric constant sufficient to triboelectrically charge the paint particles.

51. The apparatus of claim 50 wherein said material is polytetrafluorethylene.

52. The apparatus of claim 42 further comprising a screen, said screen positioned in the trough to separate out different size particles and impurities.

53. A method for depositing triboelectrically charged powder paint on a workpiece comprising the steps of:
adding paint particles to a platform lined with a material having a dielectric constant sufficient to triboelectrically charge paint particles; and
passing said paint particles through a trough lined with a material having a dielectric constant sufficient to triboelectrically charge the paint particles by inducing an angular force on the platform such that the paint particles move in the direction of said force, said angular force fluidizing and triboelectrically charging said paint particles as said paint particles oscillate against said material having a dielectric constant.

54. The method of claim 53 further comprising the step of passing a grounded workpiece through said charged paint particles.

55. The method of claim 53 further comprising the step of dipping a grounded workpiece into said trough of paint particles.

56. The method of claim 53 wherein the vibration is induced by the rotation of an unbalanced weight on a motor shaft.

57. The method of claim 53 wherein the vibration is induced by a pneumatic vibrator.

58. The method of claim 53 wherein the vibration is induced by an electromagnetic vibrator.

59. The method of claim 53 further comprising the step of passing particles that no longer are triboelectrically charged through a screen, wherein said screen separates different size particles and impurities.
